(19) United States
(12) Patent Application Publication
(10) Pub. No.: US 2010/0169771 A1
(43) Pub. Date: Jul. 1, 2010

(54) User Interface for Managing Patient Care Plans

(75) Inventors: Khalod Kelantan Pelegrin, Leawood, KS (US); Yegor F. Hanov, Overland Park, KS (US); Fran Pivonka, Lenexa, KS (US); Lisa Pastine, Shawnee, KS (US)

Correspondence Address: SHOOK, HARDY & BACON L.L.P.;(Cerner Corporation), Intellectual Property Department, 2555 GRAND BOULEVARD, KANSAS CITY, MO, 64108-2613, US

(73) Assignee: CERNER INNOVATION, INC., OVERLAND PARK, KS (US)

(21) Appl. No.: 12/347,669

(22) Filed: Dec. 31, 2008

(51) Int. Cl. G06F 3/00; G06Q 50/00

(52) U.S. Cl. 715/700; 705/3; 705/2

(57) ABSTRACT

Systems, methods, and computer-readable media for managing patient care plans are provided. In embodiments, a graphical user interface provides for the presentation and management of patient care plans. The user interface includes a plan summary area that is configured to display information relating to a patient care plan. The user interface also includes a plan detail area configured to display an activated patient care plan that is indicated by an activated icon. Additional informational icons are displayed in both the plan summary area and the plan detail area. The activated patient care plan includes orders that are displayed in an order summary area. The number of orders of the patient care plan to be signed is indicated in the plan detail area. The user interface may also include a checks alerts input to proactively check alerts before signing the orders.

### CROSS-REFERENCE TO RELATED APPLICATIONS

This application is related by subject matter to the inventions disclosed in the following commonly assigned application: U.S. application Ser. No. (not yet assigned) (Attorney Docket Number CRNI.144691), filed on even date herewith. The aforementioned application is herein incorporated by reference in its entirety.

### BACKGROUND

The modern practice of medicine poses a number of challenges for clinicians to effectively deliver quality care to patients. In particular, patients, during transitions in care, are exposed to a variety of risks. Transitions in care include changes in setting, service, practitioner, or level of care. Medication errors such as omissions, duplications, dosing errors, or overlooked drug interactions may occur frequently during such transitions. Reconciliation of medical information is done to avoid such errors. Reconciliation should be done at every transition of care whereby new medications are ordered or existing orders are rewritten.

Additionally, clinicians are exposed to a large volume of patients and orders each day. As a result, there is an expectation that clinicians will provide quality care to patients in a timely and efficient manner. Such intense expectations may increase the risk of errors or misunderstandings relating to patient orders.

Over the past decade, there has been an increased use of computers to assist clinicians in the clinical care process. In particular, clinical support systems have been developed to address the cumbersome task of maintaining paper charts. Generally, computerized clinical support systems eliminate the confusion and errors associated with paper charts. Additionally, needless waste in the health care process is eliminated.

### SUMMARY

Embodiments of the invention are defined by the claims below, not this summary. A high-level overview of various aspects of the invention are provided here for that reason, to provide an overview of the disclosure, and to introduce a selection of concepts that are further described in the detailed-description section below. This summary is not intended to identify key features or essential features of the claimed subject matter, nor is it intended to be used as an aid in isolation to determine the scope of the claimed subject matter.

The present invention relates to computing environments. More particularly, embodiments of the present invention relate to methods for use in, e.g., a patient care computing environment. Further embodiments of the present invention relate to a user interface for accessing and managing patient care plans in accordance with one or more of the described methods.

In one embodiment, a set of computer-useable instructions providing a method for managing patient care plans is illustrated. The method includes receiving input of at least one patient care plan, including at least one order. A user indication to determine if any alerts exist is received and a determination regarding the existence of any alerts is made. Upon a determination that an alert exists, the alert is presented.

In another embodiment, a set of computer-useable instructions providing a method for managing patient care plans is illustrated. The method includes receiving input from a first user to add a patient care plan, including at least one order, to a patient profile. A user indication to check for at least one alert is received. The alert is presented to the first user and a first user indicated action is received in response to the alert. A signature associated with the order is received. A second user indicated action to present an alert history associated with the patient care plan is received from a second user. The alert history is presented to the second user.

In yet another embodiment, a set of computer-useable instructions providing for the presentation of one or more user interfaces for initiating patient care plans is illustrated. The user interface includes a patient care plan summary area that is configured to display information relating to a patient care plan including at least one order. The user interface also includes a patient care plan detail area that is configured to display at least one activated patient care plan.

Additionally, embodiments of the present invention provide computer-readable media for performing the methods herein described.

Additional objects, advantages, and novel features of the invention will be set forth in part in the description which follows, and in part will become apparent to those skilled in the art upon examination of the following, or may be learned by practice of the invention.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment for managing patient care plans, in accordance with the present invention.

FIG. 2 is a flow diagram illustrating a first exemplary method for managing patient care plans, in accordance with embodiments of the present invention.

FIG. 3 is a flow diagram illustrating a second exemplary method for managing patient care plans, in accordance with embodiments of the present invention.

FIG. 4 is a flow diagram illustrating a third exemplary method for managing patient care plans, in accordance with embodiments of the present invention.

FIG. 5 is an illustrative graphical user interface display of activation of a patient care plan, in accordance with embodiments of the present invention.

FIG. 6A is an illustrative graphical user interface display of proactively checking alerts related to a patient care plan.

FIG. 6B is an illustrative graphical user interface display of an alert proactively generated.

FIG. 6C is an illustrative graphical user interface display of a patient care plan edited in response to an alert proactively generated.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention provide systems and computerized methods for accessing and managing patient care plans in a proactive and interactive manner. The present invention further provides a user interface for accessing and managing patient care plans.

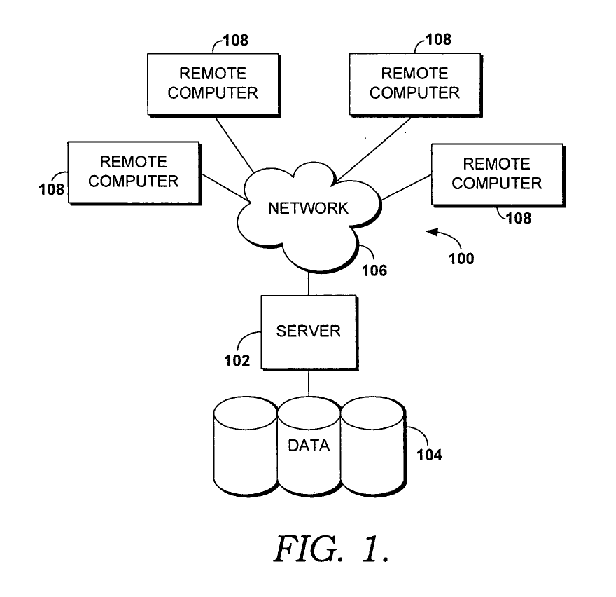

Referring now to the drawings in general, and initially to FIG. 1 in particular, an exemplary computing system environment, for instance, a medical information computing system, on which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

Embodiments of the present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

Embodiments of the present invention may be described in the general context of computer-executable instructions, such as program modules, being executed by a computer. Generally, program modules include, but are not limited to, routines, programs, objects, components, and data structures that perform particular tasks or implement particular abstract data types. Embodiments of the present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 100 includes a general purpose computing device in the form of a server 102. Components of the server 102 may include, without limitation, a processing unit, internal system memory, and a suitable system bus for coupling various system components, including database, with the server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer readable media, for instance, database 104. Computer readable media can be any available media that may be accessed by server 102, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database 104, provide storage of computer readable instructions, data structures, program modules, and other data for the server 102.

The server 102 may operate in a computer network 106 using logical connections to one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 108 may also be physically located in non-traditional medical care environments so that the entire health care community may be capable of integration on the network. The remote computers 108 may be personal computers, servers, routers, network PCs, peer devices, other common network nodes, or the like, and may include some or all of the components described above in relation to the server.

Exemplary computer networks may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the database 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server and remote computers) may be utilized.

In operation, a user may enter commands and information into the server 102 or convey the commands and information to the server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 102. In addition to a monitor, the server 102 and/or remote computers 108 may include other peripheral output devices, such as speakers and a printer.

Although many other internal components of the server 102 and the remote computers 108 are not shown, those of ordinary skill in the art will appreciate that such components and their interconnections are well known. Accordingly, additional details concerning the internal construction of the server 102 and the remote computers 108 are not further disclosed herein.

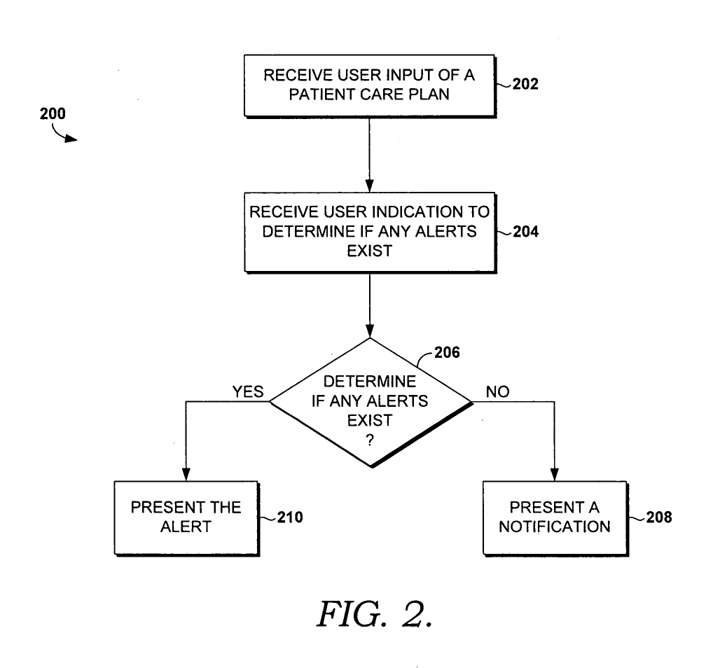

Referring now to FIG. 2, a method for managing patient care plans 200 in accordance with embodiments of the present invention is illustrated. User input of a patient care plan into a patient profile is received at block 202. A patient care plan is a medical plan that organizes action tasks relating to the care and treatment of patients. For example, a patient that is admitted to the hospital for a kidney transplant requires certain treatment and preparatory orders. The patient care plan identifies a patient's individual care plans to ensure all required actions are ordered and completed.

Patient care plans are generally selected as a pre-built patient care plan comprising at least one order. The patient care plans are pre-built in the sense that the plans may be compiled at an earlier date and contain generic orders related to the plan. For instance, a pre-built patient care plan for a laparoscopic cholecystectomy, e.g. gallbladder removal, comprises a set of related orders for that procedure. Orders related to the laparoscopic cholecystectomy may include certain medications for the procedure before or after surgery, laboratory tests generally run in relation to the surgery, radiological tests, nutrition information for patients recovering from the surgery, and the like. The orders related to a treatment plan are compiled and saved as a pre-built patient care plan and can then be customized by the user. Patient care plans can often times comprise hundreds of orders. Thus, pre-built patient care plans save a user the time and effort required to generate a new patient care plan.

Patient care plans do not have to be added to a patient profile by way of a pre-built patient care plan. A user may enter a new plan by individually selecting the orders to be added to a patient care plan or directly to the patient profile. For example, a user may wish to order laboratory tests for a particular patient. The user would add the order to perform the desired laboratory tests for the patient rather than selecting a pre-built patient care plan. The newly added order may also be added to an existing patient care plan and will be presented as part of the patient care plan.

Once a patient care plan is added to a patient profile, the user is notified if information is missing from the patient care plan. It is contemplated to be within the scope of embodiments hereof that presenting notifications may include an audible presentation, a visual presentation, or a combination of an audible and a visual presentation.

Missing information includes any patient information that may be required in the patient profile. Such information may be the height or weight of the patient, the patient's address, or the like. The missing information may also be information within the patient care plan such as a specific dosage that must be individualized for each patient. By presenting the missing information notification when the patient care plan is added to the profile, a user avoids spending time customizing a patient care plan only to find upon completion of the customization that the patient care plan contains missing information that will need to be supplied and may conflict with the customizations. By way of example only, assume a user inputs a patient care plan for a proposed treatment including a proscribed medication only to find that the patient's current medications are not contained in the patient profile. A risk of conflicting medications exists and the patient care plan that was just input may not be a possible course of action.

In addition to notifications regarding missing information, embodiments include presenting alerts to users at various points during customization of a patient care plan. Alerts exist when the patient care plan includes information that needs to be communicated to the user. By way of example only, the information to be communicated may be that patient information has not been updated recently and an alert would be generated to notify the user the information may be outdated. Alternatively, an alert may be generated because an order within the patient care plan conflicts with information in the patient profile. For instance, assume a patient care plan including a medication from the penicillin family has been added to a patient profile. The patient profile may contain information that the patient is allergic to penicillin. Such an allergic reaction would generate an alert. Alerts may also be generated if information input by the user is not within a designated range for the order, such as a dose range for a particular medication.

Embodiments may contain numerous alert levels. For instance, a first alert level could run to check alerts related to patient information. A second alert level could run to check alerts related to medications. Embodiments could be configured to check alerts via numerous alert levels and may depend on user preference.

A user may check for alerts at any time by entering a user indication to determine if at least one alert exists. A user indication to determine if any alerts exist is received at block 204 and may be received by a variety of actions. A user may choose to enter the patient care plan in its entirety and preview the orders pending a signature. Such a selection to preview the orders pending a signature will result in a user indication to check for existing alerts. A user may also choose to proactively check for existing alerts. Thus, it is not necessary to complete the customization of the patient care plan. A user is able to proactively check for existing alerts at any time to avoid the burden of alerts appearing when the user is ready to sign the patient care plan. The ability to proactively check alerts ensures a user is apprised of the effects of the patient care plan at their convenience to avoid the needless entry of a patient care plan that may be incompatible with an existing alert.

Once a user indication to determine if any alerts exist is received at block 204, a determination of whether any alerts exist is made at block 206. If the determination is that no alerts exist, a notification conveying as much is presented to the user at block 208. If it is determined at block 206 that there is at least one alert, the alert is presented to the user at block 210.

Once the alert notification is presented, varying actions may be received from the user. Such actions in response to the alert are user indicated actions. User indicated actions will vary depending on the alert presented. A user has the ability to view the alert and re-enter the patient profile to input modifications and eliminate the alert. By way of illustration and not limitation, if an alert is presented notifying the user patient information may be outdated then the user may wish to update the patient information. Additionally, a user may choose to cancel the order that prompted the alert. For instance, if the patient care plan comprises an order for a medication included in the patient profile as a potential allergy, the medication may be removed and replaced with an appropriate medication. A user may also choose to proceed with the order despite the presented alert. This may be an option when the order is necessary for the treatment plan. The user makes a determination on how to respond to the presented alert and enters a user indicated response.

In the case where the user chooses to proceed despite the presented alert, information regarding the alert override is received. Such information comprises the presented alert that is being overridden, the identity of the overriding user, the reason for overriding the alert, and the like. Collecting such information is necessary to ensure all users are informed of previous decisions regarding the patient care plan. The collected information is stored and will be available as an alert history for review by subsequent users.

Patient care plans may be created at any time and saved for later use. Patient care plans may not have been recently created and added to the patient profile. Related results are available to a user while customizing the patient care plan. Related results are useful in providing the most up to date results relating to a patient profile so a user can evaluate the pending patient care plan. The related results include results that are connected to the patient care plan. Such results may include laboratory test results that have been entered or other tests that have been ordered. The most recent decisions and results are included in the related results. The user has the option to continue customizing the plan while reviewing the related results. Such customization while reviewing the related results allows a user to modify a patient care plan to be most effective in light of the most recent information associated with the patient profile.

When a user has customized the patient care plan to their satisfaction, a signature is required. A user reviews the orders for signature which will prompt generation of existing alerts if the user did not previously check for alerts. The orders for signature comprise orders within a patient care plan or orders that have been added to the patient profile that are pending a signature. Once the orders for signature are reviewed, the user signs the patient care plan. At this time, the patient care plan may be initiated and the orders will become activated. Alternatively, the user could sign the patient care plan and save the plan for later initiation. While the plan is pending initiation, it may be reviewed by subsequent users and modified. Additional patient care plans and orders may be added to the patient profile, also.

Since configurations exist to save the patient care plan without initiating the plan, subsequent users reviewing the patient care plan will need to be apprised of previous determinations and actions regarding the patient care plan. An alert history is maintained to present previous actions related to previously presented alerts and the responses thereto. The alert history is generated upon receipt of a user indicated action. Previously presented alerts, as well as the user indicated action in response to the presented alerts and the information collected regarding the user indicated action, are displayed to the subsequent user. For instance, assume a first user input a patient care plan and overrode a presented alert before signing the orders and saved the patient care plan for later use. A second user, while initiating the patient care plan input by the first user, is presented with the same alert presented to the first user. The second user may enter a user indicated action to present the alert history and review the alert presented to the first user, the first user's identity, the date and time the alert was overridden, and the reason the alert was overridden. If no alert history is available to the second user then the second user is aware that they are the first user to view the alert. This may occur if a new alert arises after the time a patient care plan is signed and will thus not be presented to the first user. For example, a new alert could be generated relating to patient information if a certain amount of time elapses or a patient could develop a new allergy since the patient care plan was signed. Additionally, a drug recently administered after signing the patient care plan may create a new drug to drug interaction.

A second user may also save the plan for later use. If the second user has entered new orders, the process begins again at block 202 and the new orders must be signed. The second user may also initiate the patient care plan.

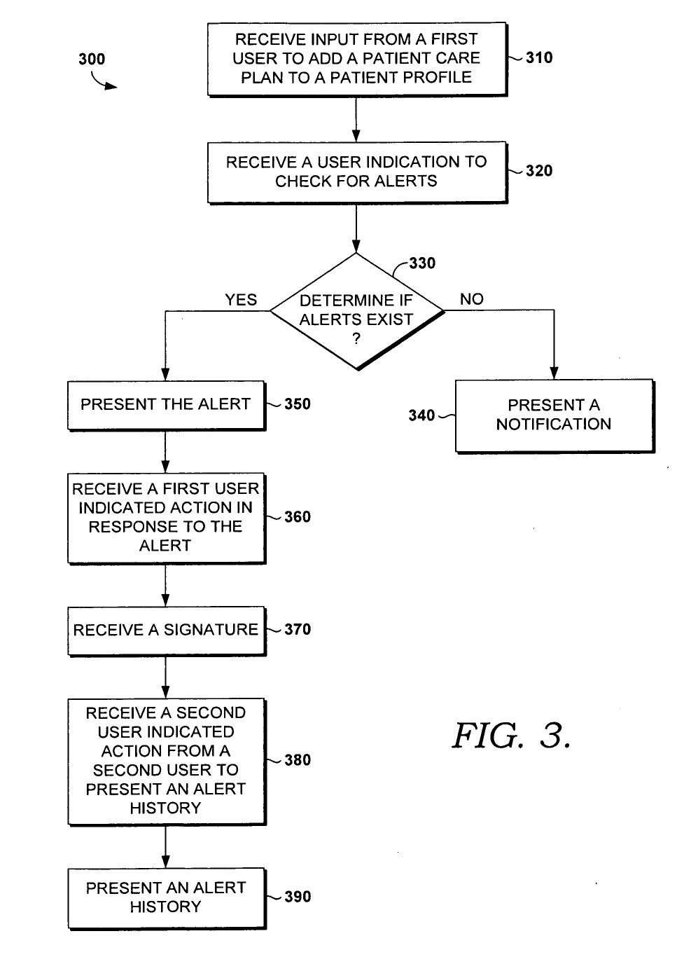

Turning now to FIG. 3, a method for managing patient care plans 300 in accordance with embodiments of the present invention is illustrated. User input from a first user to add a patient care plan to a patient profile is received at block 310.

The user is notified if information is missing from the patient care plan. The missing information notification is included when the patient care plan is added to the profile to avoid a user spending time customizing a patient care plan to find at the end of the customization that the patient care plan is missing details and may conflict with the customizations.

A user indication to check for any existing alerts is received at block 320. A user indication may be received by a variety of actions. A user may choose to enter the patient care plan in its entirety and preview the orders pending a signature. Such a selection to preview the orders pending a signature will result in a user indication to check for existing alerts. A user may also proactively choose to check for existing alerts. Thus, it is not necessary to complete the customization of the patient care plan. A user is able to proactively check for existing alerts at any time to avoid the burden of alerts appearing when the user is ready to sign the patient care plan.

Once the user indication to check for any existing alerts is received at block 320, a determination whether any alerts exist is made at block 330. If the determination is that no alerts exist, a notification conveying as much is presented to the user at block 340. If it is determined at block 330 that there is at least one alert, the alert is presented to the user at block 350. A first user indicated action by the first user is then received at block 360 in response to the presented alert.

A first user indicated action is a response to the presented alert so the first user indicated action will vary depending on the alert presented. The first user has the ability to view the alert and re-enter the patient profile to enter modifications to eliminate the alert. Additionally, the first user may choose to cancel the order that prompted the alert. The first user may also choose to proceed with the order despite the presented alert. The first user makes a determination on how to respond to the presented alert and enters the user indicated response.

In the case where the first user chooses to proceed despite the presented alert, information regarding the alert override is received. Such information comprises the presented alert that is being overridden, the identity of the overriding user, and the reason for overriding the alert. Collecting such information is necessary to ensure all users are informed of previous decisions regarding the patient care plan. The collected information is stored and will be available as an alert history for review by subsequent users.

Upon completion of customization of the patient care plan, the first user may wish to initiate the patient care plan or save the patient care plan for later initiation. Regardless of whether the patient care plan is to be saved or initiated, a signature for the orders is received at block 370.

The first user may decide to save the patient care plan. A saved patient care plan may be initiated by a second user. The second user may also be prompted to supply missing information in the same way as the first user was prompted. The second user also has the ability to review the related results. The second user is presented with alerts either by proactively checking for alerts or signing the patient care plan. The alerts presented to the second user may be newly created alerts, previously presented alerts, or a combination thereof. New alerts will be reviewed for the first time by the second user. Previously presented alerts were reviewed by the first user and are associated with an alert history. The alert history presents previous actions related to previously presented alerts and the responses thereto. The alert history is generated for review upon receipt of a second user indicated action from the second user at block 380. Previously presented alerts, as well as the first user indicated action in response to the presented alerts and the information collected regarding the first user indicated action, are presented to the second user at block 390. By reviewing the alert history, the second user may feel confident making decisions in accordance with the first user's first indicated action in response to the presented alert. The second user may continue to save the patient care plan or may initiate the patient care plan.

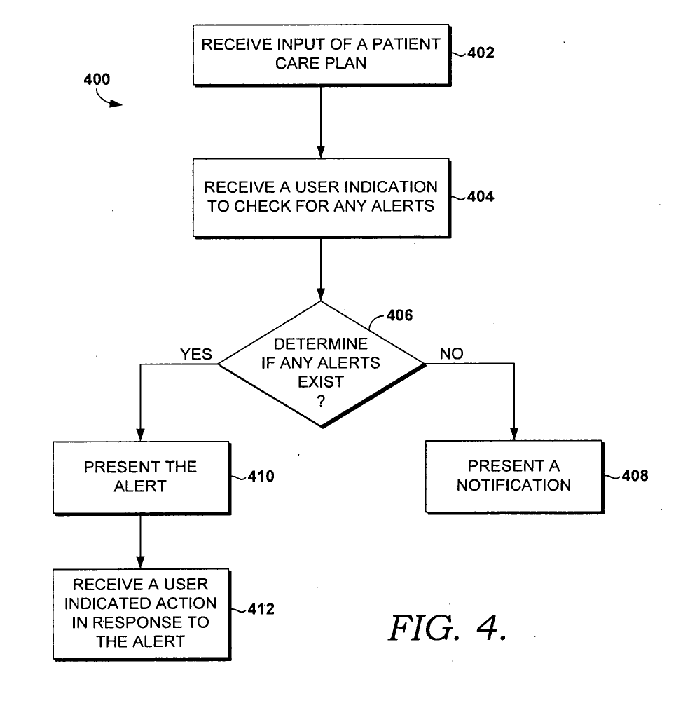

Referring now to FIG. 4, a method for managing patient care plans in accordance with embodiments of the present invention is illustrated. User input from a first user to add a patient care plan to a patient profile is received at block 402.

A user indication to check for any existing alerts is received at block 404. A user indication may be received by a variety of actions. A user may choose to enter the patient care plan in its entirety and preview the orders pending a signature. Such a selection to preview the orders pending a signature will result in a user indication to check for existing alerts. A user may also proactively choose to check for existing alerts prior to signing the orders. Thus, it is not necessary to complete the customization of the patient care plan. A user is able to proactively check for existing alerts at any time to avoid the burden of alerts appearing when the user is ready to sign the patient care plan. The ability to proactively check alerts ensures a user is apprised of the effects of the patient care plan at their convenience to avoid the needless entry of a patient care plan that may be incompatible with an existing alert.

Once the user indication to check for any existing alerts is received at block 404, a determination whether any alerts exist is made at block 406. If the determination is that no alerts exist, a notification conveying as much is presented to the user at block 408. If it is determined at block 406 that there is at least one alert, the alert is presented to the user at block 410. A user indicated action by the user is then received at block 412 in response to the presented alert.

The user indicated action in response to the presented alert will vary depending on the alert presented. The user may choose to cancel the order that generated the presented alert. The user may also choose to override the presented alert. In the case where the first user chooses to override the presented alert, information regarding the alert override is received. Such information comprises the presented alert that is being overridden, the identity of the overriding user, and the reason for overriding the alert. Collecting such information is necessary to ensure all users are informed of previous decisions regarding the patient care plan. The collected information is stored and will be available as an alert history for review by subsequent users.

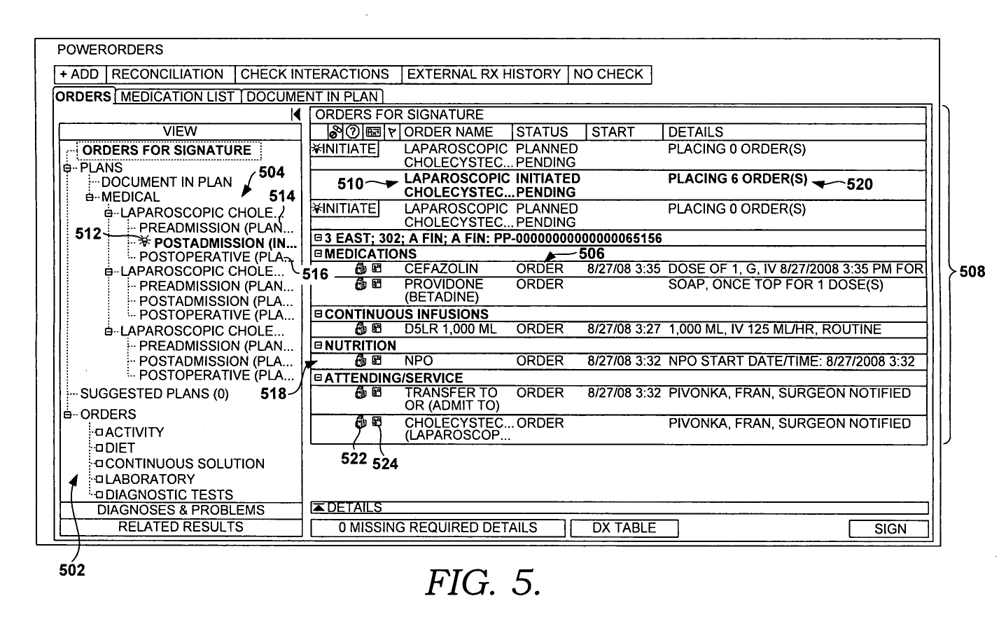

Referring now to FIG. 5, an illustrative graphical user interface display 500 is illustrated in accordance with embodiments of the present invention.

The interface comprises a plan summary area 502 that displays information relating to patient care plans 504. The patient care plans comprise at least one order 506. A plan detail area 508 is configured to display at least one activated patient care plan 510.

Activated patient care plans are patient care plans that are to be implemented rather than saved for later use. Activated care plans are designated in the plan summary area 502 by an activated icon 512 associated with the patient care plan 504. As illustrated in FIG. 5, the activated patient care plan 510 may be a phase of a patient care plan 504 that includes other patient care phases 514, 516. The activated patient care plan 510 is detailed in the plan detail area 508.

The plan detail area 508 is further configured to present an order summary area 518. The order summary area 518 displays the at least one order 506 within the activated patient care plan 510. The plan detail area 508 is further configured to display a numeral 520 corresponding to the number of orders included in the activated patient care plan 510 to be signed. The numeral 520 indicates the number of orders 506 the user will be signing into activation. The other phases 514 and 516 indicate zero orders to be placed since the phases 514 and 516 are not activated.

The plan summary area 502 and the plan detail area 508 are configured to display information icons. Informational icons are icons to convey relevant information to a user quickly. The informational icons may include icons to designate the status of a patient care plan such as the activated icon 512. An informational icon may designate the status of a patient, such as an inpatient icon 522. An order is designated as part of a patient care plan by a classification icon 524. Other informational icons not illustrated may be icons to indicate information is missing, icons to indicate a high alert is related to that order, and the like.

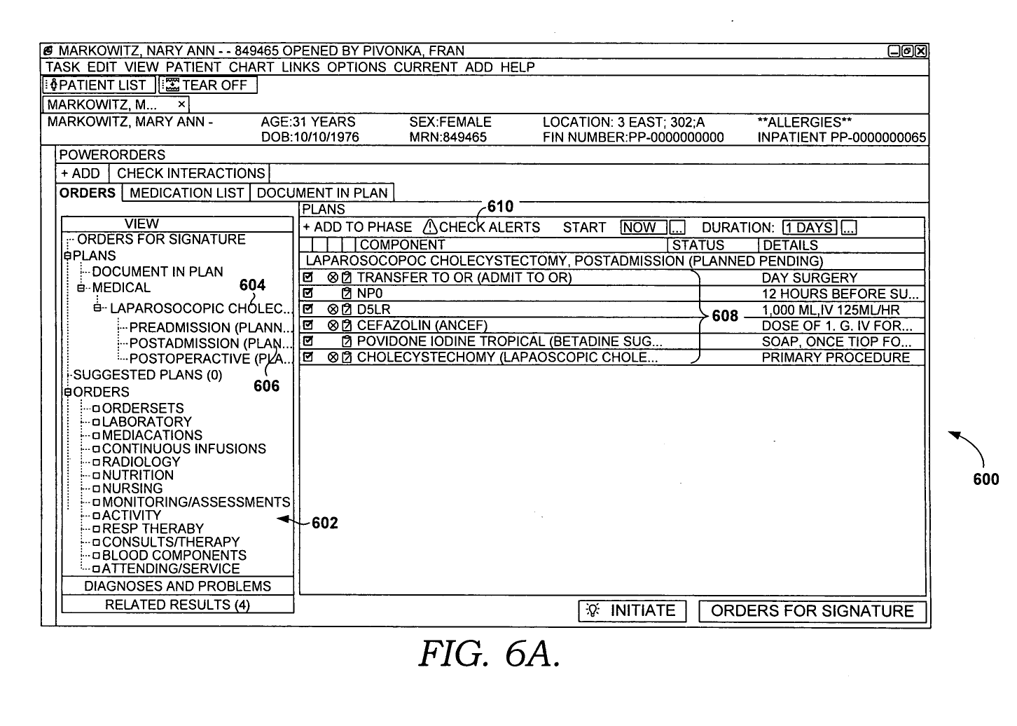

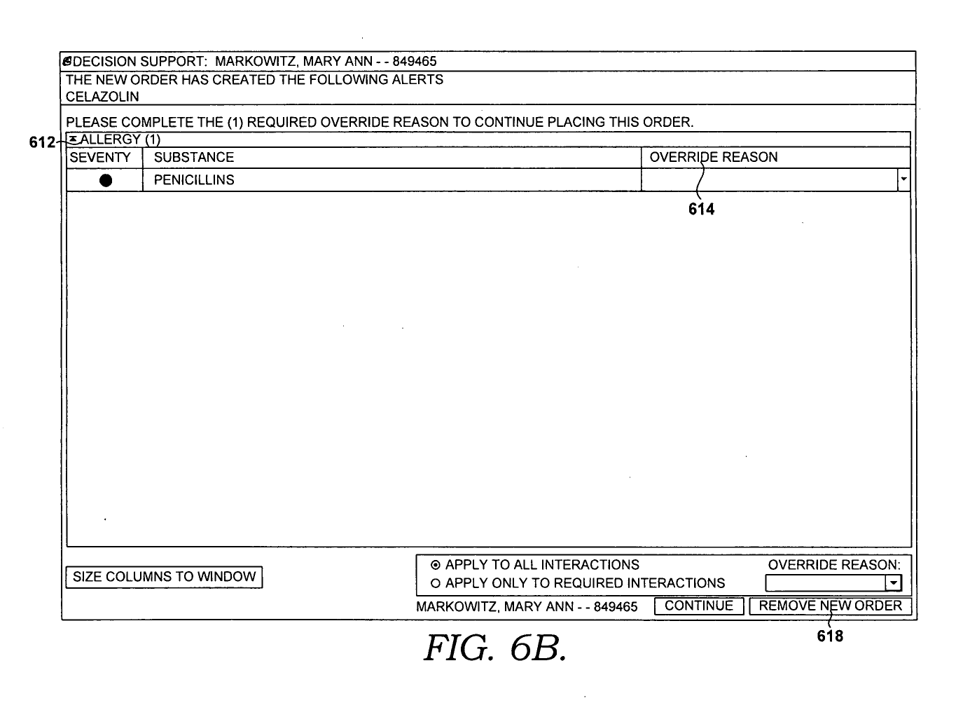

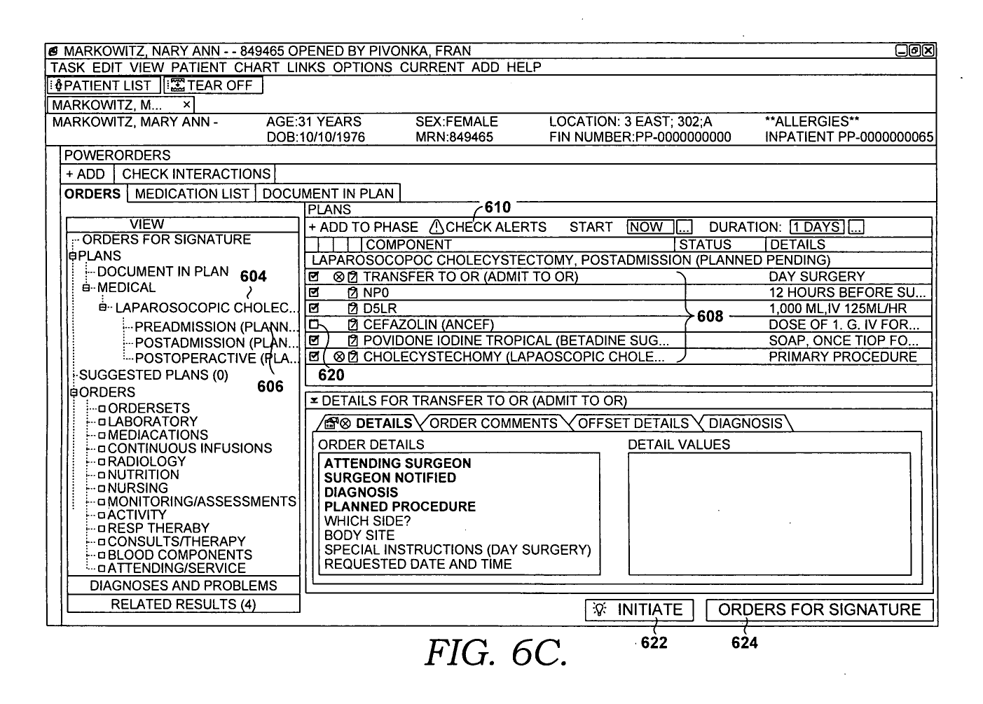

Referring now to FIG. 6A, an illustrative graphical user interface display 600 is illustrated in accordance with embodiments of the present invention. The patient summary area 602 displays patient care plan 604 that has been added to a patient profile. Patient care plan 604 comprises phase 606. Phase 606 includes a group of orders 608. While a user is adding a patient care plan 604 to a patient profile, the user may proactively check for alerts relating to the patient care plan 604 by entering a user indication to check for existing alerts. Such a user indication may be selecting the check alerts input 610 displayed within user interface display 600. An entry of the user indication to check for existing alerts prompts the alerts to begin running while the user may continue customizing the patient care plan 604.

Upon receipt of the user indication to check for existing alerts, the alerts may begin running in the background. If no alerts exist, a notification is presented to the user. If any alerts exist, an alert notification display 612 is displayed to the user, as illustrated in FIG. 6B, informing the user that the patient is allergic to penicillin. The user enters a user indicated action in response to the alert. The user may choose to cancel the order that generated the presented alert notification display 612. The user may also choose to override the presented alert notification display 612.

In the case where the user chooses to override the presented alert notification display 612, information regarding the alert override is received in an override reason input 614. An entered override reason is stored and will be available as an alert history for review by subsequent users. In the case where the user chooses to cancel the order that generated the presented alert notification display 612, the user indicated action in response to the alert would require selection of a remove new order command 618. A user indicated action in response to the alert notification display 612 to remove the new order will result in an illustrative graphical user interface display illustrated in FIG. 6C. The patient care plan 604 and phase 606 are still entered in the patient profile. Additionally, the orders 608 and the check alerts input 610 are still available for customization and selection. Since the user indicated action in response to the alert was selection of a remove new order command 618 (in FIG. 6B), the order that generated the alert has been removed from phase 606. The removal of the order is illustrated by automatically deselecting order entry input 620. From this point, the user has the option to initiate the patient care plan 604 by selecting an initiate input 622 or to review the patient care plan 604 and sign to save for later use by selecting an orders for signature input 624.

As can be understood, the present invention provides a computerized method and systems for managing patient care plans. Embodiments of the present invention further provide a user interface for accessing and managing patient care plans. Additionally, embodiments of the present invention provide an interactive approach by allowing users to add and/or modify clinical information.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the system and method. It will be understood that certain features and subcombinations are of utility and may be employed without reference to other features and subcombinations. This is contemplated and within the scope of the claims.

What is claimed is:

1. One or more computer-readable media having computer-useable instructions embodied thereon that provide for the presentation of one or more user interfaces for managing patient care plans, the one or more user interfaces comprising:
a plan summary area configured to display information relating to at least one patient care plan, wherein the patient care plan comprises at least one order; and
a plan detail area configured to display at least one activated patient care plan.

2. The media of claim 1, wherein the plan summary area is further configured to display an activated icon associated with the at least one activated patient care plan.

3. The media of claim 1, wherein the plan detail area further comprises an order summary area configured to display the at least one order within the activated patient care plan.

4. The media of claim 1, wherein the plan detail area is further configured to display a numeral corresponding to the at least one order within the activated patient care plan.

5. The media of claim 1, wherein the information relating to at least one patient care plan includes at least one phase within the at least one patient care plan.

6. The media of claim 1, wherein the plan summary area is further configured to display informational icons.

7. The media of claim 6, wherein the informational icons include patient care plan indicators, missing information icons, and alert icons.

8. The media of claim 1, wherein the plan detail area is further configured to display informational icons.

9. The media of claim 8, wherein the informational icons include patient care plan indicators, missing information icons, and alert icons.

10. One or more computer-readable media having computer-useable instructions embodied thereon that provide for the presentation of one or more user interfaces for managing patient care plans, the one or more user interfaces comprising:
a plan summary area configured to display information relating to at least one patient care plan, wherein the patient care plan comprises at least one order;
a plan detail area configured to display at least one activated patient care plan; and
a check alerts input configured to receive user input requesting to check for any existing alerts prior to receiving a signature.

11. The media of claim 10, further comprising an alert notification display.

12. The media of claim 11, further comprising an override reason input area configured to receive a reason for overriding the alert notification display.

13. The media of claim 11, further comprising a remove new order command area configured to receive user input to remove an order that generated the alert notification display.

14. The media of claim 10, wherein the plan summary area is further configured to display an activated icon associated with the at least one activated patient care plan.

15. The media of claim 10, wherein the plan detail area further comprises an order summary area configured to display the at least one order within the activated patient care plan.

16. The media of claim 10, wherein the information relating to at least one patient care plan includes at least one phase within the at least one patient care plan.
